(19) United States
(12) Patent Application Publication
(10) Pub. No.: US 2023/0072902 A1
(43) Pub. Date: Mar. 9, 2023

(54) SYSTEMS, METHODS, AND DEVICES FOR PREDICTING AND ASSESSING EMPLOYEE PERFORMANCE

(71) Applicant: Mind Wire, Inc., Phoenix, AZ (US)

(72) Inventors: Thomas Eric Riggs, Phoenix, AZ (US); Jerry Allen Rutter, Phoenix, AZ (US); Aysegul Devlet Gulenc Hosein, Phoenix, AZ (US)

(21) Appl. No.: 17/939,845

(22) Filed: Sep. 7, 2022

Related U.S. Application Data
(60) Provisional application No. 63/242,330, filed on Sep. 9, 2021.

(51) Int. Cl. G06Q 10/10; G06Q 10/06

(52) U.S. Cl. CPC G06Q 10/1053; G06Q 10/06398

(57) ABSTRACT

The system of the present disclosure may collect behavioral assessment results that correspond to a job candidate and include measurements for behavioral traits of the job candidate. The system may generate a job target for a role including a target prominence of each behavioral trait. The target prominence may include measurements selected to match a past behavioral assessment result corresponding to an employee with positive performance metrics in the role. The job target may include factor combinations reflecting the relative prominence of behavioral traits. The system may evaluate the behavioral assessment results by counting the number of factor combinations identified in the job target that are present in each of the behavioral assessment results to generate a score for each behavioral assessment result. The System may display an assessment interface with a list of the behavioral assessment results ranked based on the scores of the behavioral assessment results.

### FIELD

This application claims priority to U.S. Provisional Application No. 63/242,330 filed on Sep. 9, 2021, and entitled “SYSTEMS, METHODS, AND DEVICES FOR PREDICTING AND ASSESSING EMPLOYEE PERFORMANCE,” which is incorporated herein by reference.

### FIELD

The present disclosure relates to predicting and assessing human performance in various roles.

### BACKGROUND

Hiring can be fraught with unknowns. A resume may seem like a good fit for a role through the hiring process, but even perceived good fits can fail at a high rate. Some studies suggest that 46 percent of hires are considered failed hires after 18 months of employment. Poor hiring decisions can negatively impact a team by increasing training costs, reducing morale, and hindering workload management. Judging fit can also prove difficult from the job hunter’s side. Candidates have few tools to gain insight into their fit in a job role.

Job interviews inject a substantial amount of subjectivity and guessing into the hiring process. Candidates may like the personalities of their interviewers but ultimately dislike the realities of a job they accept. Hiring managers can similarly apply subjective criteria to exclude from consideration candidates that have a high probability of success based on behavioral traits.

Assessments such as the Predictive Index® or DiSC® aim to reduce the level of subjectivity in the hiring process, intra-team relationships, and self-understanding by using answers given in a written test to weigh personality traits. The assessments are successful in some regards, but still have limitations. Such assessment tools were not designed to take into consideration past performance, known skills, or lacking skills to evaluate the fit between a person and a role. As a result, these tools often lack an easily digestible way to assess job candidates, plan for succession, or identify skill gaps for probable career paths.

### SUMMARY

Systems, methods, and devices (collectively, the “System”) of the present disclosure may assess the fit of a job target with results from behavioral assessments. The System may collect behavioral assessment results from an online data repository. The behavioral assessment result may correspond to a job candidate and may include measurements for behavioral traits of the job candidate. The System may generate a job target for a role comprising a target prominence of each behavioral trait. The target prominence may include a range of measurements selected to match a past behavioral assessment result corresponding to an employee with positive performance metrics in the role. The job target may include factor combinations that reflects the relative prominence of behavioral traits. The system may evaluate the behavioral assessment results by counting the number of factor combinations identified in the job target that are present in each of the behavioral assessment results to generate a score for each behavioral assessment result. The System may display an assessment interface with a list of the behavioral assessment results ranked based on the scores of the behavioral assessment results.

In various embodiments, the system may collect cognitive assessment results from the online data repository. A cognitive assessment result may include a measurement of a cognitive ability of the job candidate. The job target may include a cognitive target comprising a range of cognitive scores selected to match the past cognitive assessment result corresponding to the employee with the positive performance metrics in the role. The System may assess the cognitive assessment result associated with the job candidate by checking whether a cognitive score is within the range of cognitive scores to generate a cognitive fit flag. The System may display the cognitive fit flag in the assessment interface in association with the behavioral assessment corresponding to the job candidate.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

FIG. 1A illustrates an example of a computer-based system for assessing people for fit in current and prospective roles, in accordance with various embodiments;

FIG. 1B illustrates an example computing device suitable for use in the computer-based system of FIG. 1A, in accordance with various embodiments;

FIG. 2A illustrates a process for assessing the fit of an individual for a role using a job target, in accordance with various embodiments;

FIGS. 2B and 2C illustrate an interface for assessing the fit of an individual for a role using a job target, in accordance with various embodiments;

FIG. 3A illustrates a process for career planning based in part on employee skills and skill gaps, in accordance with various embodiments; and

FIGS. 3B and 3C illustrate an interface for career planning based in part on employee skills and skill gaps, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized, and that logical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Systems, methods, and devices (collectively, “System”) of the present disclosure objectively evaluate individuals in comparison with particular job roles. The System may compile results from personality-based assessments with assessment results identifying an individual’s preferences for various work styles. The System or its users may create targets for particular job roles with the targets comprising personality characteristics or work styles more likely to describe a successful candidate than other work styles. The System may then assess how closely various individuals match a job role by comparing the assessment results for each individual to the target for a particular role.

The System may retain records of past employees and identify common traits that frequently result in success or failure for particular job roles. The System may also retain performance or assessment data for each individual in association with the corresponding behavioral assessment results. The records may be analyzed to create targets or identify trends in individuals that succeed at particular job roles. The system may use the identified job targets, comprising traits that successful hires commonly exhibit for a particular job role, to project future job roles that might suit an individual’s workstyle based on her assessment results. The System thus tends to result in objective assessments of an individual’s past, present, and likely future success in an organization.

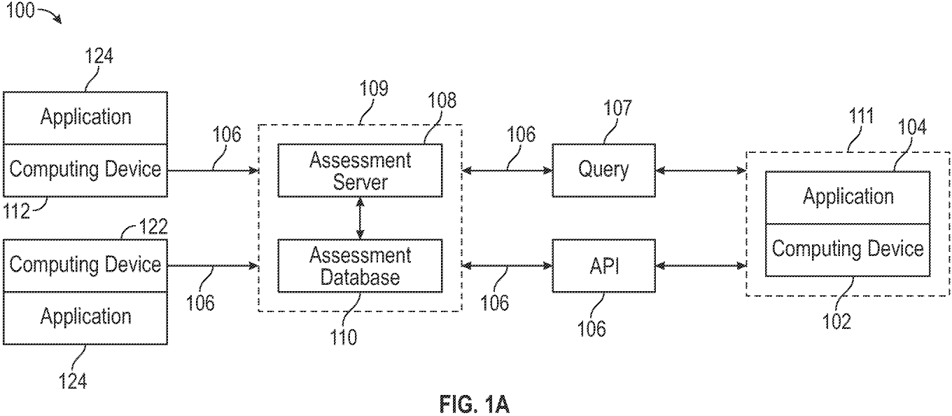

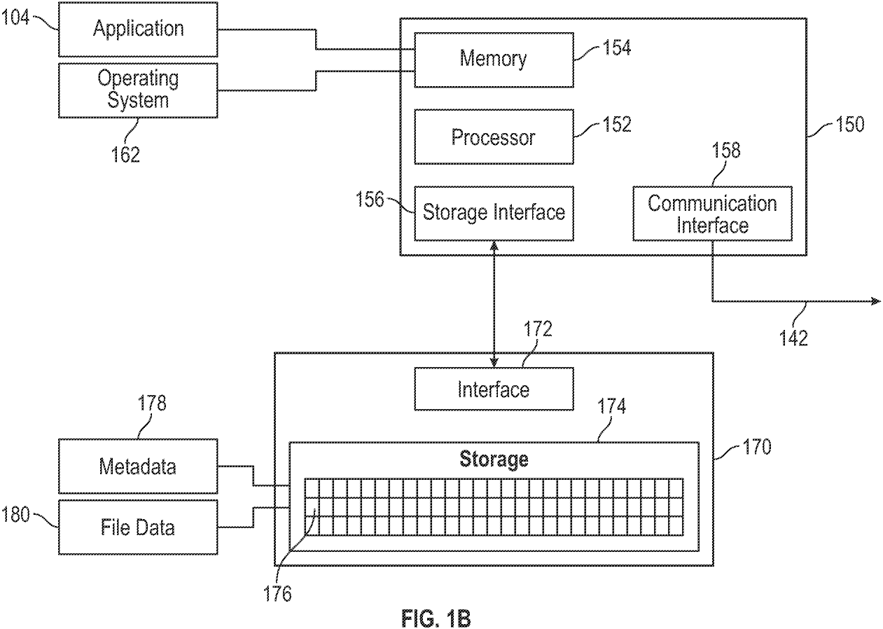

With reference to FIG. 1A, computer-based system 100 is shown for evaluating an individual’s past, present, or likely future success in organization 111. The system 100 comprises a computing and networking environment suitable for implementing aspects of the present disclosure. System 100 may comprise a computing device 102 capable of running application 104 to evaluate performance and behavioral assessments for organization 111. Computing device 102 operated by organization 111, and computing devices 112 and 124 operated by individuals, may each include one or more server, controller, a personal computer, a terminal, a workstation, a portable computer, a mobile device, a tablet, a mainframe, or other computing device suitable for communication with networked devices in System 100. System 100 may include a plurality of computing devices connected through a computer network 106, which may include the Internet, an intranet, a virtual private network (VPN), and the like. A cloud (not shown) hardware and/or software system may be implemented to execute one or more components of the system 100.

In various embodiments, application 104 running on computing device 102 may comprise a web application, a native application, or any other type of program suitable for evaluating results of behavioral assessments. Individuals may authenticate with assessment server 108 and complete an assessment accessible by the organization using application 104 running on computing device 102. Application 124 running on computing device 112 and application 122 running on computing device 122 may send answers or results of a behavioral assessment to server 108 for storage in assessment database 110 in response to an individual taking a behavioral assessment.

In various embodiments, individuals completing behavioral assessments may comprise present employees, prospective employees, or other individuals of interest to an organization. The organization may run application 104 on computing device 102 to assess or predict the future performance of the individuals that have completed a behavioral assessment. Application 104 may use application programming interface (API) calls 106, direct integration using database queries 107 or web-based requests, or other suitable programming techniques to communicate assessment results through computing device 102 with assessment server 108 and/or assessment database 110. In that regard, application 104 may retrieve, write, submit, modify, or otherwise interact with assessment results obtained or stored by assessment entity 109 in assessment server 108 or assessment database 110.

Database 110 may retain multiple data sets in support of human behavior analytics. Users may create any number of data sets to be uploaded as templates to assessment server 108. Multiple data sets may support creation of unique and different types of dashboards. By storing multiple data sets, system 100 enables users to put an employee on multiple dashboards without generating data entry errors. Users may also create different types of dashboards with the same data set using different views to access and present the same data. For example, users can combine features of the various interfaces described herein in separate interfaces. Users may share or restrict data sets with other users within the organization using access controls.

With reference to FIG. 1B and continued reference to FIG. 1A, computing device 102 and other computing devices described herein may include various electronic components such as, for example, a processing component 150 and a storage component 170. Computing devices may include one or more user interfaces for input or output such as a keyboard, mouse, track ball, touch pad, touch screen, or display. Each processing component 150 may include processor 152 and memory 154. Memory 154 may be in electronic communication with processor 152. Processor 152 may include one or more microprocessors, co-processors, logic devices, or the like. Processor 152 comprising multiple microprocessors may execute in parallel or asynchronously. The logic device may include, for example, analog-to-digital converters, digital-to-analog converters, buffers, multiplexers, clock circuits, or any other peripheral devices supporting operation of processor 152. Memory 154 may include a single memory device or multiple memory devices and may be volatile memory, non-volatile memory, or a combination thereof.

Each processing component 150 may also comprise a storage interface 156 in electronic communication with processor 152. Storage interface 156 may be configured to provide a physical connection to storage component 170. For example, in response to storage component 170 comprising an internal hard drive, storage interface 156 may include, for example, appropriate cables, drivers, and the like to enable the physical connection. As a further example, in response to storage component 170 comprising a removable storage medium, such as a CD-ROM drive, DVD-ROM drive, USB drive, memory card, and the like, storage interface 156 may comprise an interface, a port, a drive, or the like configured to receive the removable storage medium and any additional hardware suitable to operate the interface, the port, the drive, or the like.

Each processing component 150 may also comprise a communication interface 158 in electronic communication with processor 152. Communication interface 158 may be, for example, a serial communication port, a parallel communication port, an Ethernet communication port, a software port, or the like. Device 102 may comprise a communication medium 142. Communication medium 142 may be configured to enable electronic communication between processing component 150 and network 114 (of FIG. 1A). Communication medium 142 may be a cable, such as an Ethernet cable. In various embodiments, communication interface 158 may be configured for wireless communication via infrared, radio frequency (RF), optical, Bluetooth®, or other suitable wireless communication methods. Communication medium 142 may comprise one or more antennas configured to enable communication over free space. Network 114 and/or network 120 may comprise an intranet, the Internet, or a combination thereof. Each device 102 in system 100 may communicate with another device either directly or indirectly via network 114 or network 120.

In various embodiments, storage component 170 may comprise any suitable database, data structure, unstructured data store, relational database, document-based database or the like capable of storing and/or maintaining data. Storage component 170 may comprise, for example, a hard drive, a solid-state drive, magnetic tape, a removable memory card, cloud storage, an array of drives, and the like. Storage component 170 may comprise an interface 172 configured to enable communications with processing component 150, via storage interface 156. For example, storage interface 156 in processing component 150 and interface 172 in the storage component 170 define the physical layers between the processing component 150 and storage component 170, respectively, establishing communication therebetween. In various embodiments, storage component 170 includes storage 174, with multiple blocks 176, in which data and files are saved. Each file stored in the storage component 170 may include metadata 178 and file data 180. Metadata 178 for a file includes, for example, pointers to particular blocks 176 in storage 174 at which the file data 180 for the file is stored. File data may include data stored in nonvolatile storage to render a visual representation of a document or artifact to a user, launch an application, load an application into a predetermined state, retain historic application data, read or write blocks from memory 154, boot an operating system, or otherwise serve as a more permanent storage location than memory 154 for processing component 150.

In various embodiments, processor 152 in each device 102 may be configured to execute application 110 and an operating system 162 suitable to run on device 102. Operating system 162 allocates resources of device 102 and hosts services common between application 110 executing on processor 152 and memory 154. Operating system 162 may be stored on storage component 170, within memory 154, or a combination thereof depending on configuration and state of device 102. Operating system 162 may vary between device 102 and is configured to control the hardware components for the associated type of device 102. For example, a device 102 in the form of a computer might run Windows® or Linux® as operating system 162, but a device 102 in the form of a smartphone may run Android® or iOS® as operating system 162. Other devices may run custom operating systems embedded on programmable memory. Processor 152 may be configured to execute operating system 162 and each of the applications 110 stored in memory 154 or storage component 170.

In various embodiments, application 110 may include an executable, device driver, application programming interface (API), or other such routine or protocol. Application 110 may be deployed at the data access layer, stored in memory 154, or on storage component 170 and configured to be loaded onto device 102 and managed or operated by operating system 162. During power-up of the device 102, during initialization of operating system 162, or in response to a user selecting application 110, operating system 162 detects the presence of and launches application 110. In response to launching, application 110 may monitor input devices and respond to inputs using system calls to read or write storage 174 or memory 154, execute routines on processor 152, communicate through communication interface 158, or otherwise respond to detected inputs. Application 110 may include a program written in a programming language such as, for example, Go, Java®, Koltin®, Swift, Solidity, Python®, or any other suitable programming language.

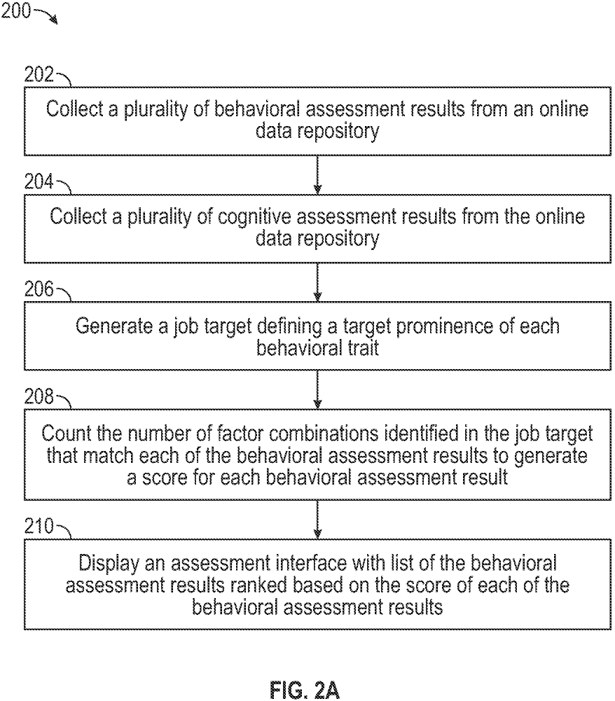

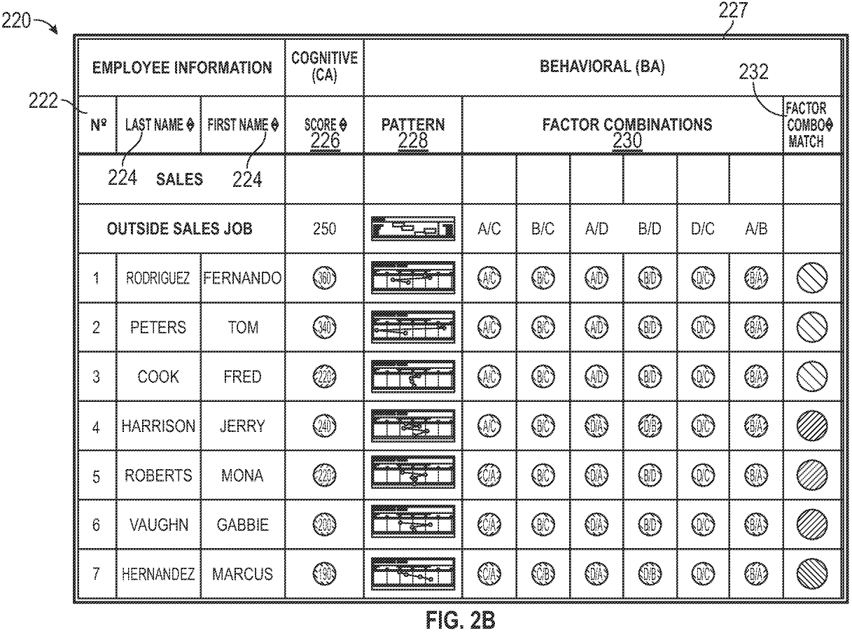

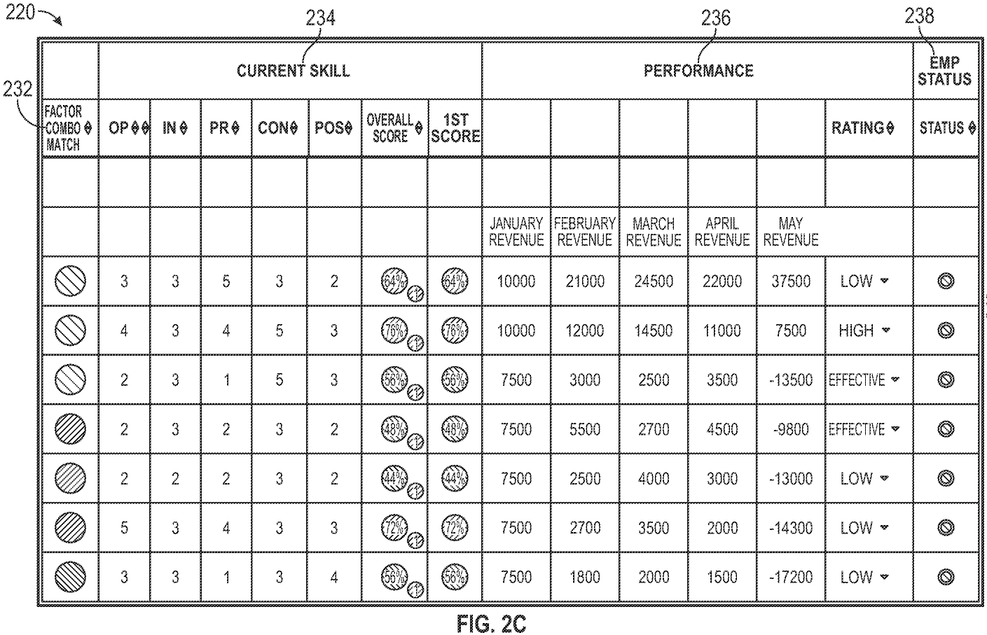

With reference to FIG. 2A, process 200 for execution by system 100 (of FIG. 1A) is shown, in accordance with various embodiments. Process 200 may assess the fit of a job target with results from behavioral assessments or cognitive assessments. Process 200 may also enable individuals to subjectively assess performance in comparison with results from behavioral or cognitive assessments. System 100 may comprise a downloadable template an organization can use to configure system 100 to receive the organization’s proprietary performance data or data regarding an individual’s skills or other characteristics. An individual may be identified using a primary key, unique identifier, or tagging in various embodiments to store identity data in association with assessment results or performance data of the individual.

In various embodiments, system 100 may collect behavioral assessment results from a data repository (Step 202). Behavioral assessment results may be hosted by a third-party specializing in workforce assessment such as, for example, the Predictive Index®, DiSC®, or other suitable behavioral assessment providers. System 100 may thus flexibly operate using various underlying assessment frameworks. Behavioral assessment results may also be collected and stored locally by system 100 or organization 111. Behavioral assessment results may be retrieved using database access techniques such as function calls, SQL calls, APIs, database connectivity libraries, NoSQL, access tools for unstructured data stores, or other suitable data retrieval techniques depending on the data storage arrangement available to system 100.

In various embodiments, each behavioral assessment result may correspond to a job candidate, employee, or other individual of interest suitable for comparison to a job target or creation of a job target. A behavioral assessment result may include measurements of behavioral traits present in an individual. For example, the Predictive Index® offers a behavioral assessment that measures behavioral traits including dominance, extraversion, patience, and formality. In another example, DiSC® measures behavioral traits including dominance, influence, steadiness, and conscientiousness. These behavioral traits may also have prominence or amplitude measurements associated with them to indicate how strongly the behavioral traits manifest in an individual. Behavioral traits may thus be compared to one another to assess factor or trait combinations. Factor combinations may tend to show which trait manifests stronger between two traits in an individual.

In various embodiments, system 100 may collect cognitive assessment results (Step 204). A cognitive assessment result may include a measurement of a cognitive ability of the job candidate. System 100 may use the same or similar techniques to collect cognitive assessment results as described above in reference to behavioral assessment results. Cognitive assessment results may be hosted by a third-party specializing in workforce assessment such as, for example, the Predictive Index® or DiSC®. System 100 may flexibly operate using various underlying assessment frameworks. System 100 may collect the cognitive assessment results from the online data repository hosted by a third-party. Cognitive assessment results may also be collected and stored locally by system 100 or organization 111. Cognitive assessment results may be retrieved using database access techniques such as function calls, SQL calls, APIs, database connectivity libraries, noSQL, access tools for unstructured data stores, or other suitable data retrieval techniques depending on the data storage arrangement available to system 100.

In various embodiments, system 100 or organization 111 may generate a job target for a role comprising a target prominence for a behavioral trait (Step 206). A job target may thus describe behavioral traits in terms of the prominence for each trait that is likely to match with an individual that will succeed in the job role. The job target prominence for a behavioral trait may comprise a range selected to match a past behavioral assessment result corresponding to an employee with positive performance metrics in the role. The job target may include factor combinations that reflects the relative prominence of each behavioral trait in the target job candidate or job target.

In various embodiments, a job target may include a desired threshold value or score relating to cognitive ability in individuals as reflected in their cognitive assessment results. Cognitive assessment results may be compared to the desired threshold value to determine whether the cognitive assessment results for a candidate satisfy the desired cognitive level for the job target. Cognitive assessment results may also be used to sort candidates showing the same or similar behavioral aptitudes for a role. In that regard, cognitive assessment results may serve as a tie breaker.

In various embodiments, system 100 may assess the cognitive assessment result associated with a job candidate by checking whether a cognitive score is within the range of cognitive scores in the job target. System 100 may use a flag or Boolean assessment to set a cognitive fit flag in response to the cognitive assessment result meeting or not meeting the score identified in the job target. System 100 may display the cognitive fit flag in the assessment interface in association with the behavioral assessment corresponding to the job candidate. System 100 may also use score ranges to assess whether a candidate is a strong cognitive fit, a moderate cognitive fit, or a poor cognitive fit for a role.

In various embodiments, behavioral assessment results or cognitive assessment results from current or former employees who have been successful may be used to create job targets. Job targets from similar roles in the same industry or analogous roles in other industries may be used to create a job target for a role. Machine learning algorithms may intake as training sets the behavioral assessment results from known successful individuals in a role to generate a job target. Success or failure of individuals hired based on the job target may be used to retrain system 100 as feedback into the machine learning algorithm to evaluate the accuracy of machine-generated job targets.

In various embodiments, system 100 may evaluate behavioral assessment results in comparison with a job target (Step 208). For example, system 100 may count the number of factor combinations identified in the job target that are present in each of the behavioral assessment results to generate a score for each behavioral assessment result. System 100 may display an assessment interface including a list of the behavioral assessment results ranked based on the score of each of the behavioral assessment results or cognitive assessment results in comparison with the job target (Step 210).

Referring to FIGS. 2B and 2C, an assessment interface 220 for display by system 100 (of FIG. 1A) is shown, in accordance with various embodiments. System 100 may send video signals in electronic format suitable for interpretation by a display. In that regard, system 100 may cause a display to manipulate pixels or otherwise display assessment interface 220 or other interfaces described herein.

In various embodiments, interface 220 may comprise a unique identifier 222 associated with an individual and identifying information 224. Identifying information 224 or unique identifier 222 may comprise an assigned number, employee number, first name, last name, or other identifying information associated with an individual. As depicted, assessment interface 220 may include information associated with an individual presented in a record or row. Assessment information may comprise cognitive assessment results 226.

In various embodiments, cognitive assessment results 226 may comprise a cognitive assessment score. Cognitive assessment results may also reflect segmented scoring ranges. For example, cognitive assessment score 226 may be depicted with a numeric value reflecting a raw score and color coding to reflect how well the score fits with a selected job target. Continuing the example, scores may be presented as green, yellow, or grey corresponding to a strong fit, moderate fit, or poor fit, respectively, for a role based on the score identified in the job target.

In various embodiments, assessment interface 220 may comprise indicators of the level of match between an individual’s behavioral assessment and a job target. For example, an individual matching three out of the four most desirable behavioral factor combinations for a job target may be indicated in green, with two out of four in yellow, and fewer in grey. System 100 may then use the cognitive assessment to rank order tied scores on factor combination matches.

In various embodiments, performance data may be associated with individuals and with behavioral assessment results or cognitive assessment results. Organizations may use system 100 to identify actions to take in response to performance assessments, identify viable performance metrics, review past results, or measure the impact of various factors on performance.

In various embodiments, assessment interface 220 may comprise behavioral assessment results 227. Behavioral assessment results 227 may include a graphical representation 228 such as a pattern from the Predictive Index® or DiSC® plot. Behavioral assessment results 227 may further comprise factor combinations 230. Factor combinations 230 may be displayed with a visual indication of whether each factor combination 230 is a fit for the job target. For example, green, yellow, and grey may represent a strong fit, a moderate fit, and a poor fit, respectively. A strong fit may indicate factor combinations 230 from a behavioral assessment result are present in a job target, moderate fit may indicate that the factor combination is neutral, and poor fit may indicate the factor combination is not present in the behavioral assessment result. Each factor combination may be aggregated into a factor combination match score 232.

In various embodiments, the factor combination match score 232 may comprise a summation of the factor combinations from the job target that are present in the individual’s behavioral assessment results. For example, four out of six matching factor combinations may be displayed as a strong fit. Three out of six factors matching may be displayed as a moderate fit. One out of six matching factors may be displayed as a poor fit. Factors may be aggregated according to any scorable formula suitable for differentiating between a strong fit, moderate fit, poor fit, or any other intervals of fit level. Fit may be determined by assessing whether the factor combination match score results in a score within a strong fit interval, moderate fit interval, or poor fit interval, for example.

In various embodiments, performance assessment data 236 for an individual may be analyzed in conjunction with that individual’s cognitive assessment data or behavioral assessment data. In that regard, an organization may integrate commercially available behavioral assessments and cognitive ability assessments with the organization’s unique performance data. The combined assessment and performance data may be used to evaluate an individual’s performance or prospective performance of other individuals in a job role.

In various embodiments, system 100 may collect quantitative or qualitative data relating to individual performance assessment data 236 or an individual’s skill data 234 through automated or manual entry. Automated entry may comprise integration of system 100 with a human resources management system used by the organization. Automated entry may use common integration techniques such as, for example, XML, JSON, flat files, APIs, data migration, data access techniques available to system 100, or other suitable techniques for moving data from one piece of data-oriented software to another. Manual entry may comprise performance targets and performance results tracked and entered by an organization. System 100 may also collect skills or competencies for individuals. Skills or competencies may be associated with the individual and the individual’s job role, and skills or competencies may similarly be collected automatically or manually and reflected in skill data 234.

In various embodiments, system 100 may track the progress of new hires against known performance indicators (KPIs) at 30 days, 60 days, 90 days, or any other suitable assessment interval. System 100 may reassess individuals and KPIs after a longer period to determine whether the job targets and behavioral assessment matches accurately predicted success. Organizations can automatically or manually integrate performance data suitable for assessing KPIs and employee performance. System 100 may align good matches between job targets and assessment results based on performance data.

In various embodiments, system 100 may also collect employment status data 238 reflecting an employee’s tenure. Employment status data 238 may include employment start dates, employment end dates, total hours worked, known employment periods, current employment status, or other representation of job experience. Tenure may be associated with an individual for each job role the individual has held at an organization. Tenure may also represent the duration of an individual’s employment relationship in the company. System 100 may also collect employment status data. Employment status data may comprise employed, active, on leave, suspended, separated, inactive, applicant, candidate, or other status indicators representative of an individual’s relationship with an organization.

In various embodiments, system 100 may identify trends that a behavioral assessment or cognitive assessment alone may be insufficient to detect. For example, system 100 may predict whether an individual is a good behavioral fit for a job role by creating a job target for comparison with assessment results. A job target may identify characteristics of previously successful individuals or individuals successful in similar roles. A job target may be created by analyzing personality traits and performance data of current and former employees that held the job role to identify the traits most associated with success or failure in the job role. The job target may then be used to match against prospective candidates for the job role.

In various embodiments, system 100 may use process 200 or interface 220 to create, refine, review, or apply job targets. In that regard, interface 220 may enable a user at organization 111 (of FIG. 1) to improve job targets and complete a feedback loop into system 100. Interface 220 may assess behavioral traits or factor combinations identified as relevant to likelihood of success in a job role. System 100 may use process 200 to assess whether individuals have the traits likely to match with the desired level of prominence for a job role. For example, system 100 may assess matching factor combinations by weight, by count, by most prevalent prominence in an individual, based on an organization’s subjective criteria, or other suitable matching techniques. In that regard, system 100 may match individuals to job targets based on personality traits (i.e., factors or combinations of factors).

In various embodiments, system 100 may measure an individual’s current skill using skill data 236. For example, an individual may take an exam to assess proficiency in desired skills. The assessment results may be integrated into system 100 and associated with the individual. For example, skill may be assessed using a leadership skill assessment or an influencing skill assessment. An organization may also manually or automatically integrate alternative skill assessment results and competencies into system 100 for association with an individual. Skill data may be accessible in association with behavioral assessment or cognitive assessment results for an individual and viewable in assessment interface 220.

In various embodiments, performance evaluation may comprise a first score that reflects the first time the individual’s skills were assessed. The performance evaluation may also comprise an overall score that reflects the number of assessments an individual has had in addition to an average score, the latest score, or another suitable performance score reflective of an individual’s skills.

In various embodiments, an individual’s score improvements may be linked with revenue dollars earned by the individual or brought in by the individual. System 100 may use performance data in conjunction with coaching data, behavioral data, and cognitive data to more accurately assess an individual or a job role. System 100 may detect the value difference between candidates meeting behavioral or cognitive thresholds of a job target. System 100 may do so by comparing the performance of individuals that match the behavioral and cognitive thresholds of a job target well with past performance of individuals that do not match the behavioral and cognitive thresholds of a job target.

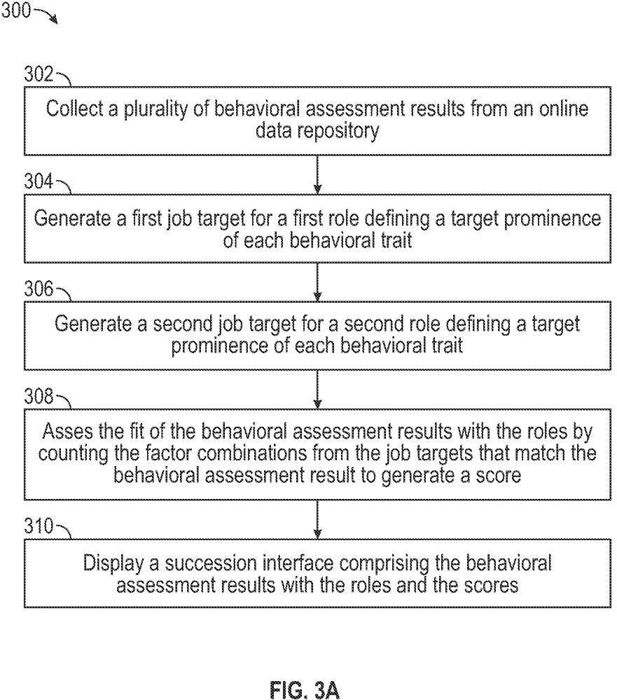

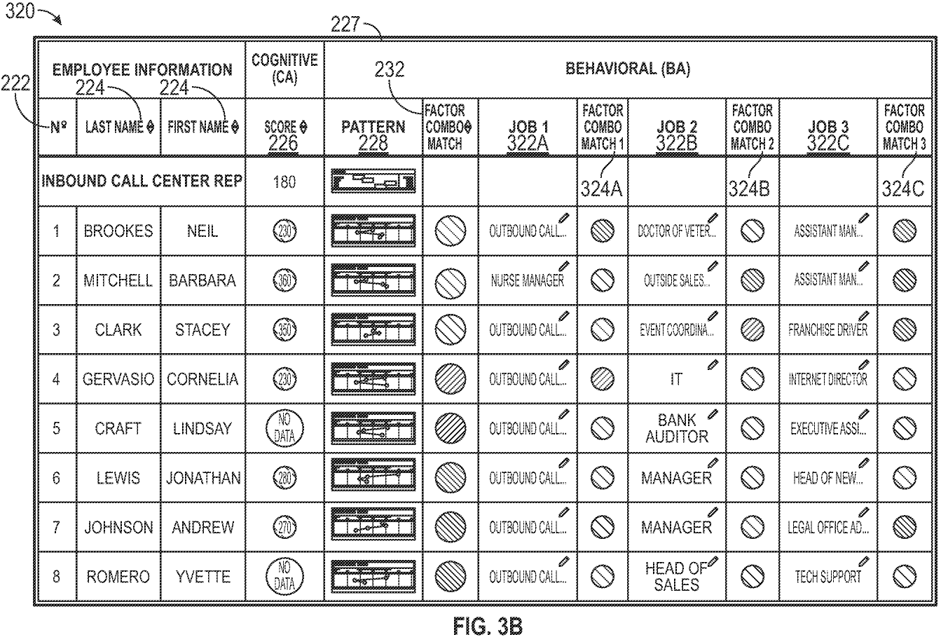

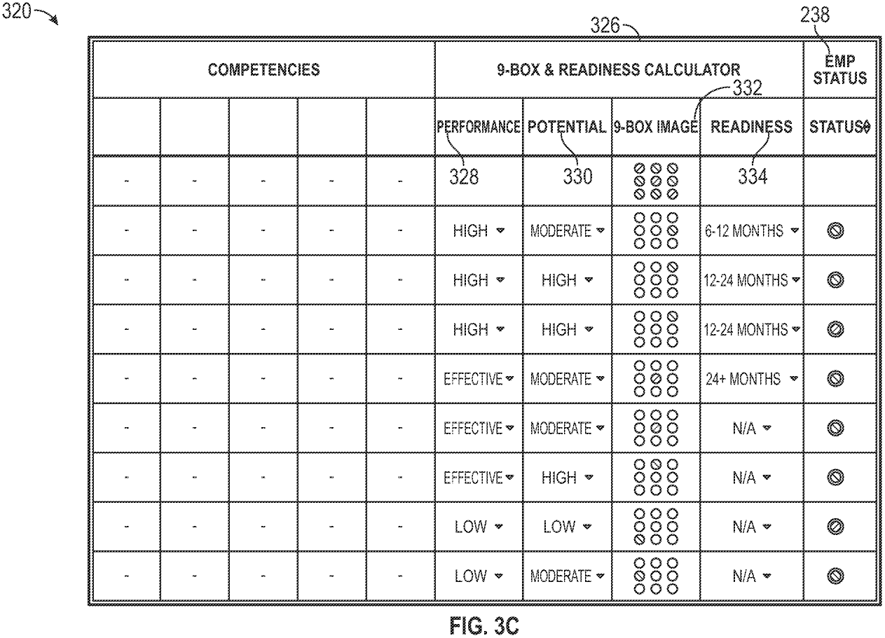

In various embodiments, system 100 may read and write assessment data and succession data globally to reflect changes to data through whichever interface data is accessed. An organization may enter performance data and status in assessment interface 220, for example, and access the same data in succession interface 320 (of FIG. 3). Interface 220 may comprise hover-over tooltips that describe to users the significance of the various performance data, behavioral assessment data, cognitive assessment data, job target, or other data pertaining to a job role or individual. System 100 may evaluate similarities between leaders and team members to identify common ground and suggested coaching tips. System 100 may also evaluate a team’s potential in a predictive manner based on the different traits of team members and likely synergies or deficiencies.

In various embodiments, system 100 may support candidate prioritization and hiring decisions using assessment interface 220. System 100 may determine different factor combinations relevant to a job target for use in assessment interface 220. Factor combinations may present in rank order, with an individual listed higher than other individuals in response to the individual having more factor combinations matching a job target than the other individuals. Threshold values may be assigned to behavioral traits and behavioral factor combinations. The threshold values may be assigned to job targets to determine whether a candidate or individual fits a job target. For example, fit based on behavioral factor combinations may be determined based on the behavioral factors in a job target.

In various embodiments, system 100 may also consider the prominence of behavioral factors and behavioral factor combinations for a job target in comparison with an individual’s assessment results. System 100 may sort or rank candidates based on the number of factor combination matches. System 100 may lookup behavioral factors to assess behavioral factor combinations. System 100 may also lookup cognitive assessment results. System 100 may rank candidates based on cognitive results or behavioral factor combinations.

Referring now to FIG. 3A, process 300 is shown for execution on system 100 (of FIG. 1) for succession planning, in accordance with various embodiments. Steps of process 200 (of FIG. 2) and process 300 may be used in conjunction with one another in various embodiments. Process 200 and process 300 may share common data points or include steps and features described in detail in reference to the other process.

In various embodiments, system 100 may collect behavioral assessment results (Step 302). Behavioral assessment results may be collected from an online repository. Behavioral assessment results may be hosted by a third-party specializing in workforce assessment such as, for example, the Predictive Index®, DiSC®, or other suitable behavioral assessment providers. System 100 may thus flexibly operate using various underlying assessment frameworks. Behavioral assessment results may also be collected and stored locally by system 100 or organization 111. Behavioral results may be retrieved using database access techniques such as function calls, SQL calls, APIs, database connectivity libraries, NoSQL, access tools for unstructured data stores, or other suitable data retrieval techniques depending on the data storage arrangement available to system 100.

In various embodiments, system 100 may generate a job target for a first role defining a target prominence of each behavioral trait (Step 304). System 100 may generate a job target for a second role defining a target prominence of each behavioral trait (Step 306). Job targets may be generated and have characteristics the same as or similar to job targets described above with reference to process 200.

In various embodiments, system 100 may assess the fit of the behavioral assessment results with the job roles by counting the factor combinations from the job targets that match the behavioral assessment result to generate a score for each job target and assessment combination (Step 308). Each job target may identify different behavioral traits, factor combinations, or cognitive thresholds from other job targets. Each job target may thus match differently with a given individual’s assessment results, skills, or performance ratings.

With reference to FIGS. 3A, 3B, and 3C, system 100 may display a succession interface 320 comprising the behavioral assessment results with the roles and the scores (Step 310). Succession interface 320 may include unique identifier 222, identifying information 224, cognitive assessment results 226, behavioral assessment results 227, and graphical representation 228, which are described above with reference to assessment interface 220.

In various embodiments, succession interface 320 may compare the fit of an individual in a first job 322A, second job 322B, third job 322C, and any other number of jobs. System 100 may thus generate a job target for job 322A, another job target for job 322B, another job target for job 322C, and another job target for other jobs for comparison with an individual’s assessment results. Job targets may be compared with an individual’s assessment results to generate factor combination match scores 324A, 324B, 324C unique to each job 322A, 322B, 322C, respectively.

In various embodiments, system 100 may assess active or terminated employment status. System 100 may check post hire at predetermined intervals (e.g., 15 days, 30 days, 60 days, 90 days, monthly, annually) to assess how many employees left a role and whether the behavioral fit was strong, moderate, or poor (e.g., green, yellow, or grey in succession interface 320). System 100 may identify if a certain team or leader is having more turnover than expected, more than other similar departments, or more than similar companies in the same or similar industries. System 100 may thus detect team-specific problems resulting in turnover, poor behavioral fits, poor cognitive fits, poor performance, or poor skill development. System 100 may also take outcomes as feedback in association with the behavioral assessment of the individual who had the outcome in a job role to refine the job target for the role and verify accuracy and efficacy.

In various embodiments, system 100 may identify people in assessment interface 220 to load into succession interface 320. System 100 may test matches for multiple jobs in a single screen. Each record may reflect any combination of an individual’s assessment results, behavioral fits, cognitive fits, or other information related to the individual in comparison with various job roles.

In various embodiments, succession interface 320 may include a 9-box & readiness calculator 326. Calculator 326 may include a performance assessment 328, potential assessment 330, 9-box image 332, readiness horizon 334, and employment status 238. Calculator 326 may thus capture how hard an individual has worked, tenure, performance, potential, or other factors as competencies. Similar to performance KPIs, calculator 326 may measure employees against competencies. Calculator 326 may include tooltips that hover over and sort individuals into boxes.

In various embodiments, system 100 may support custom interfaces combining selected features of succession interface 320, assessment interface 220, and other interfaces supported by system 100. System 100 allows users to save and name dashboards once created for later access. Access to custom interfaces can be allowed or restricted for various users and groups using access controls.

In various embodiments, users may modify the default version of assessment interface 220 or succession interface 320 and selectively exclude or include any of the varying elements of the default interfaces. System 100 may also support custom columns, which may be selectively included in assessment interface 220, succession interface 320, or any other interface supported by system 100. A user may, for example, select the default view of assessment interface 220 and add elements such performance assessment 328, potential assessment 330, 9-box image 332, readiness horizon 334, or employment status 238. This adjustability allows users to exclude any elements they choose from an interface and save the custom interface for future access.

In various embodiments, system 100 may compile a collection of job targets and compare with behavioral assessments for individuals to generate a list of jobs that are a good fit based on behavioral assessment matches or cognitive assessment matches to job targets. System 100 may also flag likely poor fits to advise organization 111 or an individual to consider wisely before placing an individual in a role.

In various embodiments, the system may allow users to download a computer readable file (e.g., csv or xls) to use for further analysis in other applications. The system may choose the desired assessments to display results based on the date of initial assessment, most recent evaluation, or any other order suitable for presenting a particular assessment for review and analyzed. The system may choose the desired factor combinations (e.g., BA and CA). The system may also track how many times a person has completed a skills assessment.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used, the phrase means that A alone may be present in an embodiment, B alone may be present in an embodiment, C alone may be present in an embodiment, or that any combination of the elements A, B and C may be present in a single embodiment; for example, A and B, A and C, B and C, or A and B and C. Stated another way, “or” is not necessarily exclusive as used herein. Different cross-hatching is used throughout the figures to denote different parts but not necessarily to denote the same or different materials.

Devices, systems, and methods are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. A process for assessing a fit of a job target with results from behavioral assessments, comprising:
collecting a plurality of behavioral assessment results from an online data repository,
wherein a behavioral assessment result from the plurality of behavioral assessment results corresponds to a job candidate,
wherein the behavioral assessment result comprises measurements for a plurality of behavioral traits of the job candidate;
generating a job target for a role comprising a target prominence of each behavioral trait from the plurality of behavioral traits,
wherein the target prominence comprises a range of measurements selected to match a past behavioral assessment result corresponding to an employee with positive performance metrics in the role,
wherein the job target comprises a plurality of factor combinations that reflects a relative prominence of each behavioral trait from the plurality of behavioral traits;
assessing the behavioral assessment results by counting a number of factor combinations identified in the job target that are present in each of the behavioral assessment results to generate a score for each behavioral assessment result; and
displaying an assessment interface comprising a list of the behavioral assessment results ranked based on the score of each of the behavioral assessment results.

2. The process of claim 1, further comprising collecting a plurality of cognitive assessment results from the online data repository, wherein a cognitive assessment result from the plurality of cognitive assessment results comprises a measurement of a cognitive ability of the job candidate.

3. The process of claim 2, wherein the job target further comprises a cognitive target including a range of cognitive scores selected to match a past cognitive assessment result corresponding to the employee with the positive performance metrics in the role.

4. The process of claim 3, further comprising assessing a cognitive assessment result associated with the job candidate by checking whether a cognitive score is within the range of cognitive scores to generate a cognitive fit flag.

5. The process of claim 4, further comprising displaying the cognitive fit flag in the assessment interface in association with the behavioral assessment result corresponding to the job candidate.

6. A process for succession planning, comprising:
collecting a plurality of behavioral assessment results from an online data repository,
wherein a behavioral assessment result from the plurality of behavioral assessment results corresponds to a job candidate,
wherein the behavioral assessment result comprises measurements for a plurality of behavioral traits of the job candidate;
collecting a plurality of cognitive assessment results from the online data repository,
wherein a cognitive assessment result from the plurality of cognitive assessment results comprises a measurement of a cognitive ability of the job candidate;
generating a first job target for a first role comprising a first target prominence for each behavioral trait from the plurality of behavioral traits,
wherein the first job target reflects a first relative prominence of each behavioral trait from the plurality of behavioral traits;
generating a second job target for a second role comprising a second target prominence for each behavioral trait from the plurality of behavioral traits,
wherein the second job target comprises a second plurality of factor combinations that reflects a second relative prominence of each behavioral trait from the plurality of behavioral traits;
assessing a first fit of the behavioral assessment results with the first role by counting a first plurality of factor combinations from the first job target that match the behavioral assessment result to generate a first score;
assessing a second fit of the behavioral assessment results with the second role by counting the second plurality of factor combinations from the second job target that match the behavioral assessment result to generate a second score; and
displaying a succession interface comprising the behavioral assessment results in association with the first role and the first score and in association with the second role the second score.

7. The process of claim 6, wherein the first target prominence comprises a first range of measurements selected to match a past behavioral assessment result corresponding to a first employee with positive performance metrics in the first role.

8. The process of claim 7, wherein the first job target comprises a first plurality of factor combinations that reflects the first relative prominence of each behavioral trait from the plurality of behavioral traits.

9. The process of claim 6, wherein the succession interface comprises a performance assessment, a potential assessment, and a 9-box image.

10. The process of claim 6, wherein a cognitive assessment result from the plurality of cognitive assessment results is displayed in the succession interface in a row with the behavioral assessment result in response to the behavioral assessment result and the cognitive assessment result assessing the job candidate.

11. A computer-based system for assessing a fit of a job target with results from behavioral assessments and succession planning, comprising:
a processor; and
a tangible, non-transitory memory configured to communicate with the processor, the tangible, non-transitory memory having instructions stored thereon that, in response to execution by the processor, cause the computer-based system to perform operations comprising:
collecting a plurality of behavioral assessment results from an online data repository,
wherein a behavioral assessment result from the plurality of behavioral assessment results corresponds to a job candidate,
wherein the behavioral assessment result comprises measurements for a plurality of behavioral traits of the job candidate;
assessing the behavioral assessment results by counting a number of factor combinations identified in a first job target that are present in each of the behavioral assessment results to generate a first score for each of the behavioral assessment results; and
displaying an interface comprising the behavioral assessment results in association with a first role and a first score and in association with a second role and a second score.

12. The computer-based system of claim 11, wherein the operations further comprise collecting a plurality of cognitive assessment results from the online data repository.

13. The computer-based system of claim 12, wherein a cognitive assessment result from the plurality of cognitive assessment results is displayed in the interface in a row with the behavioral assessment result in response to the behavioral assessment result and the cognitive assessment result assessing the job candidate.

14. The computer-based system of claim 11, wherein the interface comprises a performance assessment, a potential assessment, and a 9-box image.

15. The computer-based system of claim 11, wherein a target prominence comprises a range of measurements selected to match a past behavioral assessment result corresponding to a first employee with positive performance metrics in the first role.

16. The computer-based system of claim 15, wherein the job target comprises a plurality of factor combinations that reflects a relative prominence of each behavioral trait from the plurality of behavioral traits.

17. The computer-based system of claim 11, wherein the operations further comprise collecting a plurality of cognitive assessment results from the online data repository, wherein a cognitive assessment result from the plurality of cognitive assessment results comprises a measurement of a cognitive ability of the job candidate.

18. The computer-based system of claim 17, wherein the job target further comprises a cognitive target including a range of cognitive scores selected to match a past cognitive assessment result corresponding to a first employee with positive performance metrics in the first role.

19. The computer-based system of claim 18, wherein the operations further comprise assessing a cognitive assessment result associated with the job candidate by checking whether a cognitive score is within the range of cognitive scores to generate a cognitive fit flag.

20. The computer-based system of claim 19, wherein the operations further comprise displaying the cognitive fit flag in the assessment interface in association with the behavioral assessment corresponding to the job candidate.
